(19) United States
(12) Patent Application Publication
(10) Pub. No.: US 2025/0287168 A1
(43) Pub. Date: Sep. 11, 2025

(54) 3D AUDIO GENERATING DEVICE, 3D AUDIO REPRODUCTION DEVICE, 3D AUDIO GENERATION METHOD, 3D AUDIO GENERATING PROGRAM, AND MEMORY MEDIUM

(71) Applicant: TOPPAN HOLDINGS INC., Tokyo (JP)

(72) Inventors: Yukina INADA, Taito-ku (JP); Fumina KOMIYAMA, Taito-ku (JP)

(73) Assignee: TOPPAN HOLDINGS INC., Tokyo (JP)

(21) Appl. No.: 19/214,188

(22) Filed: May 21, 2025

Related U.S. Application Data
(63) Continuation of application No. PCT/JP2023/042057, filed on Nov. 22, 2023.

(30) Foreign Application Priority Data
Nov. 25, 2022 (JP) 2022-188445
Nov. 25, 2022 (JP) 2022-188446

(51) Int. Cl. H04S 7/00; G06F 3/16

(52) U.S. Cl. CPC H04S 7/301; G06F 3/165; H04S 2400/11

(57) ABSTRACT

A 3D audio generating device of a 3D audio system places, in response to an instruction from a user via an input device, an object in a virtual space showing a trajectory of motion corresponding to the instruction. The 3D audio generating device generates 3D audio data in which a selected sound is configured with a source position of the sound that moves along the object.

### CROSS-REFERENCE TO RELATED APPLICATIONS

The present application is a continuation of and claims the benefit of priority to International Application No. PCT/JP2023/042057, filed Nov. 22, 2023, which is based upon and claims the benefit of priority to Japanese Application No. 2022-188445, filed Nov. 25, 2022 and Japanese Application No. 2022-188446, filed Nov. 25, 2022. The entire contents of these applications are incorporated herein by reference.

### BACKGROUND OF THE INVENTION

### Field of the Invention

The present invention relates to a three-dimensional (3D) audio generating device, a 3D audio reproduction device, a 3D audio generation method, a 3D audio generating program, and a memory medium.

### Description of Background Art

For example, JP 2022-34160 A describes a system that has multiple speakers provided so as to surround a user who is playing a video game and creates a 3D sound field by controlling the output of each speaker according to the movements of the character controlled by the user. The entire contents of this publication are incorporated herein by reference.

### SUMMARY OF THE INVENTION

According to one aspect of the present invention, a 3D audio generating device includes a control unit including circuitry that places an object in a virtual space in response to an instruction from a first user via an input device and generates 3D audio data in which a selected sound is configured with a source position of the sound such that the source position matches a position of the object.

According to another aspect of the present invention, a 3D audio generation method includes placing an object in a virtual space in response to an instruction from a first user via an input device, using one or more computers, and generating 3D audio data in which a selected sound is configured with a source position of the sound such that the source position matches a position of the object, using the one or more computers.

According to yet another aspect of the present invention, a non-transitory computer readable memory medium stored therein a 3D audio generating program that when executed, causes one or more computers to place an object in a virtual space in response to an instruction from a first user via an input device, and generate 3D audio data in which a selected sound is configured with a source position of the sound so that the source position matches a position of the object.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram illustrating an overall configuration of a 3D audio system of an embodiment;

FIG. 2 is a diagram illustrating a functional configuration of a control device of a 3D audio generating device according to the embodiment;

FIG. 3 is a diagram illustrating an example of a hardware configuration of the control device of the 3D audio generating device according to the embodiment;

FIG. 4 is a diagram illustrating procedures of processing by the 3D audio generating device according to the embodiment;

FIG. 5 is a diagram illustrating an example of a screen displayed by the 3D audio generating device according to the embodiment;

FIG. 6 is a diagram schematically illustrating the contents of processing by the 3D audio generating device according to the embodiment;

FIG. 7 is a diagram illustrating a functional configuration of a control device of a 3D audio reproduction device according to the embodiment;

FIG. 8 is a diagram illustrating an example of a hardware configuration of the control device of the 3D audio reproduction device according to the embodiment;

FIG. 9 is a diagram illustrating procedures of processing by the 3D audio reproduction device according to the embodiment;

FIG. 10 is a diagram illustrating an example of a screen displayed by the 3D audio reproduction device according to the embodiment; and

FIG. 11 is a diagram illustrating procedures of processing by the 3D audio reproduction device according to the embodiment.

### DETAILED DESCRIPTION OF THE EMBODIMENTS

Embodiments will now be described with reference to the accompanying drawings, wherein like reference numerals designate corresponding or identical elements throughout the various drawings.

### Overall Configuration of 3D Audio System

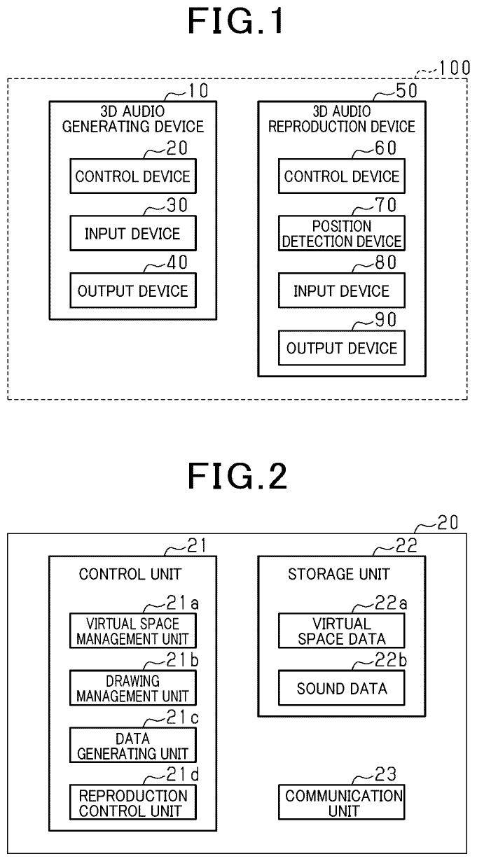

An overall configuration of a 3D audio system will be described with reference to FIG. 1. As shown in FIG. 1, a 3D audio system 100 includes a 3D audio generating device 10 and a 3D audio reproduction device 50. The 3D audio generating device 10 is a device that generates 3D audio data. The 3D audio reproduction device 50 is a device that reproduces sound based on the 3D audio data. The 3D audio data includes at least sound information and position information. The sound information is information that indicates how the pitch and length of sounds change, in other words, music data such as a song or natural sounds. The position information is information that indicates the position of the source of the sound indicated by the sound information in a 3D space. The user of the 3D audio generating device 10 and the user of the 3D audio reproduction device 50 may be the same person or different people.

The 3D audio generating device 10 includes a control device 20, an input device 30, and an output device 40. The input device 30 receives instructions input through actions of the user and sends a signal corresponding to the input to the control device 20. The actions of the user include operations on the input device 30, such as pressing a button, and body movements, such as gestures and hand movements. The output device 40 includes a display unit and a sound output unit. Upon receiving data or signals from the control device 20, the output device 40 displays images on the display unit and outputs sounds from the sound output unit. The control device 20 generates a virtual space and displays it on the display unit of the output device 40, and also generates 3D audio data based on an instruction on the virtual space received from the user through the input device 30.

The control device 20, the input device 30, and the output device 40 may be assembled together, or at least some of the components of these devices may be provided separately from the other components. The control device 20 may be connected to components of the input device 30 and the output device 40 via a wired or wireless connection. Signals and data may be exchanged between the control device 20 and the components of the input device 30 and the output device 40 using communication via a network such as the Internet or short-range wireless communication such as Bluetooth (registered trademark). In that case, each of the devices 20, 30, and 40 only needs to have a communication function corresponding to the communication scheme to be used.

The 3D audio generating device 10 may also include a position detection device that detects the position and posture of the user. The position detection device sends a signal corresponding to the detected position and posture to the control device 20.

For example, an example in which the control device 20 and the output device 40 are integrated is a head-mounted display for virtual reality VR. In that case, a controller attached to the head-mounted display is the input device 30, and the 3D audio generating device 10 also includes the position detection device described above. The position detection device includes an inertial sensor, a light emitting device, such as an infrared emitting device, and a light receiving device that receives the emission, or a head tracking device such as a camera. The input device 30 is configured to be able to detect, as the actions of the user, body movements such as gestures and hand movements as well as operations on the input device 30. The input device 30 includes an inertial sensor, a light emitting device, such as an infrared emitting device, and a light receiving device that receives the emission, and a motion capturing device such as a camera. The input device 30 may also serve as at least part of the position detection device.

It is also possible that, for example, the 3D audio generating device 10 is a head-mounted display in which the control device 20, the input device 30, and the output device 40 are integrated together. In that case, the 3D audio generating device 10 does not need to have a controller separate from the head-mounted display. For example, the input device 30 detects the line of sight of the user wearing a head-mounted display to select an object in a menu area or a virtual space displayed on the output device 40 of the head-mounted display. Further, for example, the input device 30 detects the movement of the hands or fingers of the user to deform or move an object in the menu area or virtual space. Such an input device 30 can be any input device as long as it includes a camera provided in the head-mounted display.

Alternatively, the control device 20 may be a server, a personal computer, a smartphone, or the like. If the control device 20 is a server, 3D audio data can be generated for users in parallel using the input device 30 and the output device 40 for each user. The input device 30 may be a mouse, a keyboard, a touch panel, or the like. The display unit of the output device 40 can by any display unit as long as it includes a display panel such as a liquid crystal panel, and the sound output unit of the output device 40 may be a speaker, earphones, headphones, or the like.

The 3D audio reproduction device 50 includes a control device 60, a position detection device 70, an input device 80, and an output device 90. The position detection device 70 detects the position and orientation of the user in real space, and sends a signal corresponding to the detected position and orientation to the control device 60. For example, the position detection device 70 is carried by or worn by a user, and detects the position and orientation of the position detection device 70 as the position and orientation of the user. Alternatively, the position detection device 70 may be provided above the user, such as on the ceiling of the facility in which the 3D audio is to be reproduced, to detect the position and orientation of the user.

The input device 80 receives instructions input by the actions of the user and sends a signal corresponding to the input to the control device 60. The output device 90 includes a display unit and a sound output unit. Upon receiving data or signals from the control device 60, the output device 90 displays images on the display unit and outputs sounds from the sound output unit. Specifically, an image of the real space and an image based on data from the control device 60 are superimposed and displayed by the display unit. The image of the real space may be any image of the real space around the user, such as an image transmitted through the display unit, or an image captured by an imaging unit provided in the 3D audio reproduction device 50.

The control device 60 instructs the output device 90 to reproduce the 3D audio data based on the position and orientation of the user in real space.

The control device 60, the position detection device 70, the input device 80, and the output device 90 may be assembled together, or at least some of the components of these devices may be provided separately from the other components. The control device 60 may be connected to components of the position detection device 70, the input device 80, and the output device 90 via a wired or wireless connection. Signals and data may be exchanged between the control device 60 and the components of the position detection device 70, the input device 80, and the output device 90 using communication via a network such as the Internet or short-range wireless communication such as Bluetooth (registered trademark). In that case, each of the devices 60, 70, 80, and 90 only needs to have a communication function corresponding to the communication scheme to be used.

For example, an example in which the control device 60, the position detection device 70, the input device 80, and the output device 90 are integrated is a smartphone or a tablet terminal. The position detection device 70 includes an inertial sensor, and a light emitting device, such as an infrared emitting device, and a light receiving device that receives the emission. The input device 80 includes a touch panel. The display unit of the output device 90 can be any display unit as long as it includes a display panel such as a liquid crystal panel, and the sound output unit of the output device 90 may be a speaker, earphones, headphones, or the like.

Alternatively, the control device 60 may be a server. If the control device 60 is a server, 3D audio data can be produced for users in parallel using the position detection device 70, the input device 80, and the output device 90 for each user. The control device 60, the position detection device 70, and the output device 90 may be integrated into a head-mounted display for augmented reality (AR) or mixed reality (MR). The input device 80 may also be part of the head-mounted display, or the input device 80 may be a controller. When the position detection device 70 is installed at a distance from the user, the position detection device 70 may include a light emitting device, such as an infrared emitting device, and a light receiving device that receives the emission, or a head tracking device such as a camera.

The 3D audio generating device 10 and the 3D audio reproduction device 50 may be capable of transmitting and receiving data to and from each other via a network such as the Internet. In that case, the 3D audio generating device 10 may transmit the generated 3D audio data to the 3D audio reproduction device 50.

### Configuration of 3D Audio Generating Device

The detailed configuration of the control device 20 of the 3D audio generating device 10 will be described. In this embodiment, in a virtual space VS that is a virtual 3D space generated by the control device 20, the user draws a line to specify the source position of the sound that forms part of the 3D audio.

First, with reference to FIG. 2, a functional configuration of the control device 20 will be described. As shown in FIG. 2, the control device 20 includes a control unit 21 and a storage unit 22. In addition, when the control device 20 communicates with the input device 30 and the output device 40, the control device 20 includes a communication unit 23. The communication unit 23 performs processing for communication between the control device 20 and the input device 30 or the output device 40, such as connection with a device with which it desires to communicate, and transmission and reception of data.

The control unit 21 executes a 3D audio generating program stored in the storage unit 22 to function as a virtual space management unit 21a, a drawing management unit 21b, a data generating unit 21c, and a reproduction control unit 21d.

The virtual space management unit 21a generates the virtual space VS. The virtual space VS may be a space in which no objects are placed, or a space in which objects such as structures and natural objects in accordance with the theme of the 3D audio to be created are placed. The virtual space management unit 21a instructs the display unit of the output device 40 to display an image of the virtual space VS as seen from a viewpoint in the virtual space VS.

In addition, the virtual space management unit 21a manages the positions of drawing objects that are objects used to draw lines in the virtual space VS. The drawing objects include an operated object that is moved to draw a line, and a movement assist object that is used to expand the movement range of the operated object.

The virtual space management unit 21a also manages the display of a menu area for instructing sound selection and reproduction of the generated audio data.

The drawing management unit 21b draws lines in the virtual space VS according to instructions provided by the user via the input device 30. In other words, the drawing management unit 21b generates a linear object at a position indicated by the user. This linear object is a trajectory line TL. The drawing management unit 21b records the position of the trajectory line TL in the virtual space VS and the drawing speed of the trajectory line TL reflecting the action of the user.

The data generating unit 21c generates 3D audio data based on the data of target sound that is the selected sound and the position and drawing speed of the trajectory line TL. To be more specific, the data generating unit 21c sets the position of the source of the target sound so that it moves along the trajectory line TL, sets the reproduction speed of the target sound to a speed corresponding to the drawing speed, and generates 3D audio data that includes information indicating these settings. As a result, the source position of the target sound is set to 3D coordinates that match the coordinates of the trajectory line TL.

In other words, the target sound is a sound whose source position is to be specified. The 3D audio data generated by the data generating unit 21c includes reproduction speed information indicating the reproduction speed of the sound, in addition to the sound information and position information.

The reproduction control unit 21d controls the reproduction of the 3D audio data generated by the data generating unit 21c. To be more specific, the reproduction control unit 21d instructs the output device 40 to reproduce the sound represented by the 3D audio data at a volume corresponding to the set source position and at the set speed.

The storage unit 22 stores various programs and data necessary for the control unit 21 to execute processes. For example, the storage unit 22 stores a 3D audio generating program. The storage unit 22 stores, as examples of such data, virtual space data 22a and sound data 22b.

The virtual space data 22a includes data necessary for generating the virtual space VS, such as information on a 3D orthogonal coordinate system set for the space, position information of objects placed in the space, and information for drawing.

The sound data 22b is data of sounds that can be selected as a target sound. The sound data 22b contains information corresponding to the above-mentioned sound information, and the sound represented by the sound data 22b is not configured with a source position. In one example, when a 3D audio whose theme is the sea is to be created, the sound data 22b may contain sounds representing the sounds of waves, the cries and flapping of seagulls, the cries and movement of whales, and the like.

The storage unit 22 also stores 3D audio data generated by the data generating unit 21C.

Next, the physical configuration, that is, the hardware configuration, of the control device 20 having the above functions will be described. The control device 20 is a computer device and includes an electronic circuit that serves as a computing device such as a central processing unit (CPU), a micro processing unit (MPU), or a graphics processing unit (GPU); a memory such as a read only memory (ROM), a random access memory (RAM), a registered memory, or an unbuffered memory; and a storage such as a solid state drive (SSD) or a hard disk drive (HDD). The computing device loads the operating system and various programs from the storage into a memory, and executes instructions retrieved from the memory. The control device 20 may include an integrated circuit such as an application specific integrated circuit (ASIC) or a field programmable gate array (FPGA).

When the control device 20 includes the communication unit 23, the control device 20 includes a communication interface. The communication interface is implemented as hardware, software, or a combination of both.

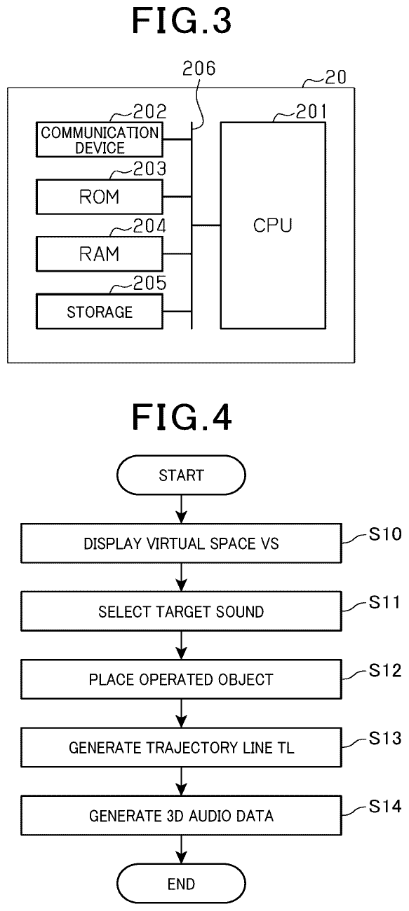

FIG. 3 shows an example of a hardware configuration of the control device 20. The control device 20 includes a CPU 201, a communication device 202, a ROM 203, a RAM 204, and a storage 205. The CPU 201 is connected to each of the communication device 202, the ROM 203, the RAM 204, and the storage 205 via a bus 206 so that data and signals are transmitted via the bus 206. In this configuration, the CPU 201, the ROM 203, and the RAM 204 correspond to the control unit 21, the storage 205 corresponds to the storage unit 22, and the communication device 202 corresponds to the communication unit 23.

The control device 20 is not limited to a control device that performs all the processes by software. As described above, the control device 20 may include a dedicated hardware circuit (for example, an application-specific integrated circuit (ASIC)) that performs hardware processing for at least some of the processes it performs. That is, the control device 20 may be configured as circuitry that includes: (1) one or more processors that operate according to a computer program (software); (2) one or more dedicated hardware circuits that execute at least some of various processes; or (3) a combination of these. The processor may include a computing device, such as a CPU, and a memory, such as a RAM and a ROM, and the memory may store program codes or instructions that are configured to cause the computing device to perform processes. The memory, which is a computer-readable medium, may be any usable medium that is accessible by a general purpose or dedicated computer.

The functions of the control device 20 may be realized by information processing devices. An information processing device is a single computer device. In other words, the control device 20 may be composed of one or more information processing devices.

### Operation of 3D Audio Generating Device

Operation of the 3D audio generating device 10 will be described with reference to FIGS. 4 to 6. FIG. 4 shows a flow of processing by the 3D audio generating device 10.

As shown in FIG. 4, when the use of the 3D audio generating device 10 is started, based on an instruction from the control device 20, an image of the virtual space VS as seen from an initial viewpoint is displayed on the display unit of the output device 40 (S10). The initial viewpoint may be a viewpoint within a predetermined virtual space VS. If the 3D audio generating device 10 is configured to be able to detect the position and posture of the user, the initial viewpoint may be set within the virtual space VS according to the position and posture of the user.

The viewpoint can be changed from the initial viewpoint according to an instruction from the user via the input device 30, or in response to a change in the position or posture of the user detected by the 3D audio generating device 10. The control device 20 moves the viewpoint in response to the instruction or a change in the position or posture of the user, and controls the display on the output device 40 so that the movement of the viewpoint is reflected in the display on the display unit.

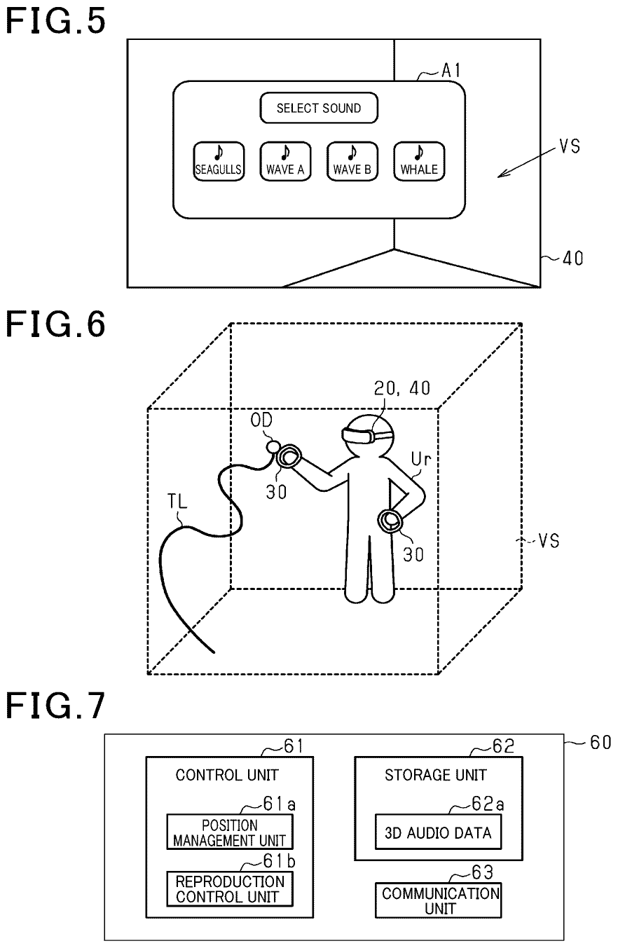

Next, the target sound is selected based on an instruction from the user (S11). For example, when a predetermined operation is made on the input device 30, the control device 20 causes the display unit of the output device 40 to display a menu area. When a section in the menu area indicating a sound selection is selected, the control device 20 causes the display unit of the output device 40 to display a sound selection area Al showing selectable sounds. FIG. 5 shows an example of the sound selection area A1. The user selects a desired sound in the sound selection area Al via the input device 30, and the selected sound is set as the target sound.

Once the target sound is selected, the control device 20 places an operation object in the virtual space VS (S12). As a result, the operated object is reflected in the display on the display unit of the output device 40. The operated object has a shape and size that allows the user to grab it, such as a circle or a sphere, and is placed near the viewpoint of the user in the virtual space VS. The operated object may have an appearance that indicates the target sound by using characters or the like.

According to an instruction from the user via the input device 30, the control device 20 moves the operated object, and generates the trajectory line TL at a position corresponding to the trajectory of the movement of the operated object (S13). As a result, the movement and trajectory line TL of the operated object is reflected in the display on the display unit of the output device 40.

Specifically, the user places the operated object at a desired start point, for example by grabbing it, and moves the operated object from the start point along a desired trajectory to a desired end point. The result is the trajectory line TL formed along the positions through which the operated object has passed.

FIG. 6 shows a schematic diagram of how the trajectory line TL is generated when the 3D audio generating device 10 is embodied in a head-mounted display and its controller, and the movement of the operated object is instructed by the user moving his or her hand. For ease of understanding, FIG. 6 shows a view of the virtual space VS from the outside with a user Ur located at a viewpoint position set in the virtual space VS.

As shown in FIG. 6, the trajectory line TL is formed in the virtual space VS at a position where the operated object OD has passed. An image of the virtual space VS seen from the viewpoint is displayed on the display unit of the output device 40, and the area of the virtual space VS displayed on the display unit changes as the viewpoint moves in response to movements of the user. When the user operates a controller, that is, the input device 30 to grab the operated object OD, and moves the controller by moving his or her hand, the operated object OD moves so as to reflect the movement of the hand, that is, the movement of the controller. The trajectory line TL is drawn along positions through which the operated object OD has passed, at a speed corresponding to the speed of the movement of the operated object OD.

For example, the trajectory line TL can be formed so as to surround the user Ur, or the trajectory line TL can be formed so as to form a picture or pattern depicting the outline of an animal, plant, or the like. A movement assist object may be used to move the operated object OD to an area that is out of reach, such as an area above. For example, the movement assist object is rod-shaped, and the operated object OD is supported by the tip of the movement auxiliary object. The user can grab and move the movement assist object so that the operated object OD can be moved further than when the user grabs and moves the operated object OD.

Returning to FIG. 4, once the trajectory line TL is generated, the control device 20 sets source positions of the target sound along the trajectory line TL, and generates 3D audio data by setting the reproduction speed of the target sound to a speed corresponding to the drawing speed of the trajectory line TL (S14). In other words, the control device 20 sets the source position of the target sound so that it moves over time from the start point to the end point of the trajectory line TL. The movement speed of the source position preferably corresponds to the drawing speed of the trajectory line TL. In addition, the control device 20 sets the reproduction speed depending on the source position of the target sound so that the reproduction speed of the target sound is high at positions where the drawing speed of the trajectory line TL is high, and the reproduction speed of the target sound is low at positions where the drawing speed of the trajectory line TL is low. In other words, the reproduction speed is set so that the position and drawing speed of the trajectory line TL correspond to the source position and reproduction speed of the target sound.

The 3D audio data is thus generated. According to the 3D audio generating device 10 of this embodiment, the user can three-dimensionally specify the sound source position by drawing a line in a 3D space. This enables creating 3D audio by an intuitive action. The reproduction speed can also be specified intuitively by changing the drawing speed.

In the flow shown in FIG. 4, the control unit 21 performs the processing of S10 and S12 as the virtual space management unit 21a, the processing of S11 and S13 as the drawing management unit 21b, and the processing of S14 as the data generating unit 21c.

When the user wishes to check the sound based on the generated 3D audio data, the user can cause the 3D audio generating device 10 to reproduce the sound using the 3D audio data by selecting a section of the menu area indicating sound reproduction. To be more specific, the control device 20 instructs the output device 40 to reproduce the sound represented by the sound information contained in the 3D audio data at a volume corresponding to the source position indicated by the position information and at a speed indicated by the reproduction speed information. The control unit 21 performs this processing as the reproduction control unit 21d.

For example, the closer the source position in the virtual space VS is to the position of the user, that is, the viewpoint of the user, the larger the volume. Alternatively, the sound is attenuated when the distance between the source position and the position of the user is equal to or greater than a predetermined distance. Alternatively, the sound is muted when the distance between the source position and the position of the user is equal to or greater than a predetermined distance. In addition, the volumes of sounds output from of the left and right earphones or speakers that form the sound output unit are controlled according to the direction of the source position relative to the viewpoint of the user so that the user perceives the sound to be coming from the source position.

Any volume control can be performed taking into consideration the position of the audio output unit relative to the user. When the position of the user in the virtual space VS changes, the volume is changed according to the change in the distance and direction from the position of the user to the source position.

While sound based on the 3D audio data is being reproduced, the control device 20 preferably moves a mark indicating the source position of sound in the virtual space VS along the trajectory line TL as the source position moves. In other words, the control device 20 causes the display unit of the output device 40 to display an image of the virtual space VS in which the source position of sound is indicated on the trajectory line TL. This allows the user to visually grasp the change in source position while the sound is being reproduced, and in turn allows the user to grasp the created 3D audio more intuitively.

By repeating the processing of S11 to S14 in FIG. 4, the source position and reproduction speed are set for each of target sounds according to the trajectory line TL of each target sound. This provides 3D data configured so that these target sounds are output in a superimposed manner. When this 3D audio data is reproduced, each sound is reproduced so that the source position changes from the start point to the end point of the trajectory line TL of that sound, at a reproduction speed in accordance with the drawing speed of the trajectory line TL for that sound.

Therefore, even complex 3D audio that has sounds emitted from different sources positions that change can be easily created through intuitive actions.

For example, when creating a 3D audio whose theme is the sea, the user may select the sound of seagulls and draw a trajectory line TL that surrounds the space above the user, select the sound of waves and draw a trajectory line TL that extends beside the user, and select the sound of a whale and draw a trajectory line TL that surrounds the feet of the user. When the generated 3D audio data is reproduced, the user hears sounds as if seagulls are circling above the user, waves are passing by the user, and whales are swimming around the feet of the user.

Therefore, according to the 3D audio generating device 10 of the present embodiment, it is possible to create diverse and flexible 3D audio through intuitive actions.

### Modifications

The configuration and operation of the 3D audio generating device 10 described above may be modified as follows.

The object generated in the virtual space VS in response to an action by the user is not limited to a continuous line, but may be a dot-like object, a planar object, a broken line that is interrupted by gaps, or the like. A planar object can be considered as, for example, a collection of dots, or an object indicating an area filled with lines. In short, it suffices if an object showing a trajectory of motion corresponding to an instruction from a user given via the input device 30 is placed in the virtual space VS in response to that instruction. The position of the object can be used as the source position of the target sound.

For example, if the target sound is the sound of rain, and the user moves as if he or she is drawing dots to express rain, dot-like objects are placed at the positions indicated by this action. The source position of the target sound is set to move among the dot-like objects. This creates a 3D audio of the sound of rain whose source position moves among dots in the order in which the dots were drawn.

Further, for example, if source positions of the target sound are set along a broken line object, when the 3D audio data is reproduced, the sound is reproduced so that its source position changes along the broken line, and the sound is interrupted where the broken line is interrupted.

The source position of the target sound does not necessarily need to follow the order in which the object was drawn, as long as it is set to move along the object. For example, if the object is a linear trajectory line TL, the source position may be set so as to move from the end point to the start point of the trajectory line TL, that is, in a direction opposite to the progress of the drawing. Further, for example, if the object is a planar object, the source position may be set so as to move from behind the surface towards the front of the surface with respect to the user. When the movement of the source position is set so as to differ from the progress of the drawing as in the above cases, it suffices if the movement of the source position can be set by instructions from the user via the input device 30 after the drawing or object is generated.

When the source position is set to follow the progress of the drawing, 3D audio can be created more intuitively, whereas when the source position can be set to differ from the progress of the drawing, there is more freedom in the movement of the source position, and more diverse expressions can be achieved by the 3D audio.

After generating the object indicating the trajectory described above, the user may be able to use the input device 30 to instruct at least one of changes in the size of the object, such as an increase or decrease, and the movement of the position of the entire object within the virtual space VS. This makes it possible to change the area in the virtual space VS in which the source position of the target sound is located. According to such configuration, 3D audio can be edited intuitively and easily, similar to how general images are edited.

The 3D audio data may be configured with elements other than the source position and reproduction speed of the sound. For example, the directivity of the sound may be set. Specifically, it may be possible to set whether the sound is emitted in all directions from the source position, or in a specific direction, such as a direction toward the user or a direction away from the user. Information specifying such sound directivity is contained in the 3D audio data as directivity information.

The speed based on which the reproduction speed is determined, that is, the speed recorded as the drawing speed, may be changeable after the object is generated. Alternatively, the reproduction speed may be changeable after the object is generated, or may be set as desired regardless of the drawing speed of the object.

The target sound for which the movement of the source position is to be set in association with the object may be changeable after the object is generated. For example, the timbre or texture of the target sound may be changeable. As a specific example, when the target sound is the sound of rain, the target sound can be changed from a sound of light rain to a sound of heavy rain. As another specific example, when the target sound is footsteps, the target sound can be changed from a sound of normal footsteps such as “thump thump” to a sound of dry metallic footsteps such as “clank clank”. Therefore, it is also possible to change the texture of the event expressed by the target sound by changing the timbre and texture of the target sound.

According to such configuration, after listening to the created 3D audio, the user can change the timbre and texture of the sound so that it matches his or her image, allowing the user to edit the 3D audio intuitively and easily.

The appearance of the object may be changed according to the target sound. For example, the pitch of the target sound may be expressed by the color of the object. Specifically, when the target sound is a high-pitched sound, the object has a warm color, and when it is a low-pitched sound, the object has a cool color. Further, for example, if an effect such as reverberation is applied to the target sound, the appearance of the object may be changed according to the effect. Specifically, the effect of the target sound may be expressed by the thickness and texture of the trajectory line TL. The appearance may vary within a single object. The effect of the target sound may be possible to be set after the object is generated.

In the 3D audio data, a reverberation effect according to the source position may be applied to the sound. In other words, a reverberation effect is set based on the structure of the virtual space VS and the source position to take into account the reverberation within the virtual space VS.

The virtual space VS may be a space in which the user can behave the same way as in a real space such as a store or an event venue. The user may create 3D audio sound by placing sounds around the structures and decorations in the virtual space VS. The virtual space VS may be generated based on data of an existing virtual space or by acquiring drawing data of a space.

Upon reproduction of 3D audio data, an object having an appearance corresponding to the sound may be used as a mark indicating the source position of the sound. For example, an object having a decorative shape such as a star may be used, or if the sound is the cry of a seagull, an object in the shape of a seagull may be used.

Trajectory identification information may be displayed near an object indicating the trajectory. An example of the identification information is a file name. The display of the identification information may be placed within the virtual space VS, or may be included in the image displayed on the output device 40. According to such configuration, when an object indicating the trajectory, such as a trajectory line TL, is generated for each of target sounds, it is possible to easily identify the correspondence between the target sounds and the trajectories.

The 3D audio data may contain information indicating a sound for which the source position is not specified, in other words, a sound that is output at a predetermined volume regardless of the location of the user. Such sound may function as BGM (Background Music) when the 3D audio data is reproduced.

When the 3D audio data is configured so that sounds whose source positions are specified are output in a superimposed manner, the reproduction start time and reproduction end time of each sound may be able to be set as desired for each sound. Such adjustment related to the timeline of reproduction of each sound may be made using a 2D plane in which one of the two axes represents time. The 2D plane may be displayed on the output device 40 together with the virtual space VS, or may be displayed separately from the virtual space VS.

### Configuration of 3D Audio Reproduction Device

The detailed configuration of the control device 60 of the 3D audio reproduction device 50 will be described. The 3D audio reproduction device 50 is used, for example, at an event or the like, to provide a specific situation, in other words, a scene produced using 3D audio to a user in a real space.

First, with reference to FIG. 7, a functional configuration of the control device 60 will be described. As shown in FIG. 7, the control device 60 includes a control unit 61 and a storage unit 62. In addition, when the control device 60 communicates with the position detection device 70, the input device 80, and the output device 90, the control device 60 includes a communication unit 63. The communication unit 63 performs processing for communication between the control device 60 and the position detection device 70, the input device 80, or the output device 90, such as connection with a device with which it desires to communicate, and transmission and reception of data.

The control unit 61 executes a 3D audio reproduction program stored in the storage unit 22 to function as a position management unit 61a and a reproduction control unit 61b.

Based on signals from the position detection device 70, the position management unit 61a acquires the position and orientation of the user in the real space RS that is a 3D space where the user is actually present. The position and orientation of the user in the real space RS may be relative to a reference position in the real space RS.

For example, the position detection device 70 may use a sensor technology that utilizes light, such as light detection and ranging (LiDAR), to record the positions of structures in the real space RS in three dimensions, and the position and orientation of the user are calculated based on the detected distances between the position detection device 70 and the structures.

In addition, the position management unit 61a associates the real space RS with an audio space AS. The audio space AS is a virtual 3D space in which the source position of sound is specified by 3D audio data 62a stored in the storage unit 62. When the 3D audio data 62a is data generated by the 3D audio generating device 10, the audio space AS coincides with the virtual space VS.

The reproduction control unit 61b uses the 3D audio data 62a to instruct the sound output unit of the output device 90 to reproduce the sound according to the position and orientation of the user acquired by the position management unit 61a. In other words, the reproduction control unit 61b controls the volume according to the positional relationship between the user and a position in the real space RS corresponding to the source position of the sound in the audio space AS, based on the correspondence between the real space RS and the audio space AS.

When a condition such as a position of the user that is preset as a trigger for switching scenes is met, the reproduction control unit 61b instructs the sound output unit of the output device 90 to switch the sound to be reproduced.

The storage unit 62 stores various programs and data necessary for the control unit 61 to execute processes. For example, the storage unit 62 stores a 3D audio reproduction program. The storage unit 62 stores, as examples of such data, the above-described 3D audio data 62a.

The 3D audio data 62a includes at least sound information and position information. As described above, the audio information is information that indicates how the pitch and length of sound change, and the position information is information that specifies the source position of the sound indicated by the source information in the audio space AS. The 3D audio data 62a may be data generated by the 3D audio generating device 10, or may be data generated by a device other than the 3D audio generating device 10.

Next, the physical configuration, that is, the hardware configuration, of the control device 60 having the above functions will be described. The control device 60 is a computer device and includes an electronic circuit that serves as a computing device such as a CPU, MPU, or GPU; a memory such as a ROM, RAM, a registered memory, or an unbuffered memory; and a storage such as an SSD or HDD. The computing device loads the operating system and various programs from the storage into a memory, and executes instructions retrieved from the memory. The control device 60 may include an integrated circuit such as an ASIC or an FPGA.

When the control device 60 includes the communication unit 63, the control device 60 includes a communication interface. The communication interface is implemented as hardware, software, or a combination of both.

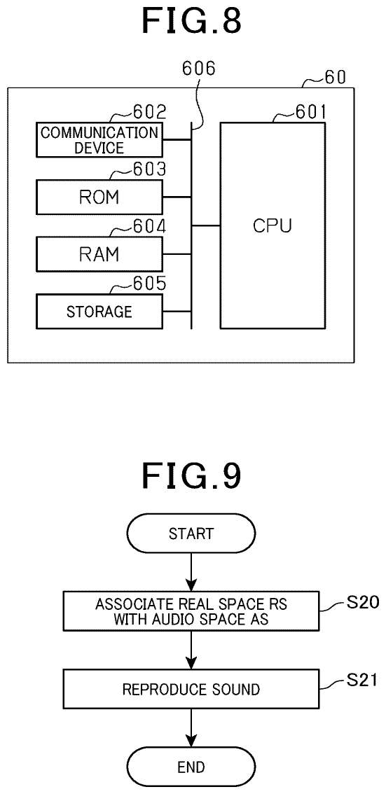

FIG. 8 shows an example of a hardware configuration of the control device 60. The control device 60 includes a CPU 601, a communication device 602, a ROM 603, a RAM 604, and a storage 605. The CPU 601 is connected to each of the communication device 602, the ROM 603, the RAM 604, and the storage 605 via a bus 606 so that data and signals are transmitted via the bus 606. In this configuration, the CPU 601, the ROM 603, and the RAM 604 correspond to the control unit 61, the storage 605 corresponds to the storage unit 62, and the communication device 602 corresponds to the communication unit 63.

The control device 60 is not limited to a control device that performs all the processes by software. As described above, the control device 60 may include a dedicated hardware circuit (for example, an application-specific integrated circuit (ASIC)) that performs hardware processing for at least some of the processes it performs. That is, the control device 60 may be configured as circuitry that includes: (1) one or more processors that operate according to a computer program (software); (2) one or more dedicated hardware circuits that execute at least some of various processes; or (3) a combination of these. The processor may include a computing device, such as a CPU, and a memory, such as a RAM and a ROM, and the memory may store program codes or instructions that are configured to cause the computing device to perform processes. The memory, which is a computer-readable medium, may be any usable medium that is accessible by a general purpose or dedicated computer.

The functions of the control device 60 may be realized by information processing devices. An information processing device is a single computer device. In other words, the control device 60 may be composed of one or more information processing devices.

### Operation of 3D Audio Reproduction Device

Operation of the 3D audio reproduction device 50 will be described with reference to FIGS. 9 to 11. FIG. 9 shows a flow of processing by the 3D audio reproduction device 50.

As shown in FIG. 9, when the use of the 3D audio reproduction device 50 is started, the control device 60 associates the real space RS with the audio space AS (S20).

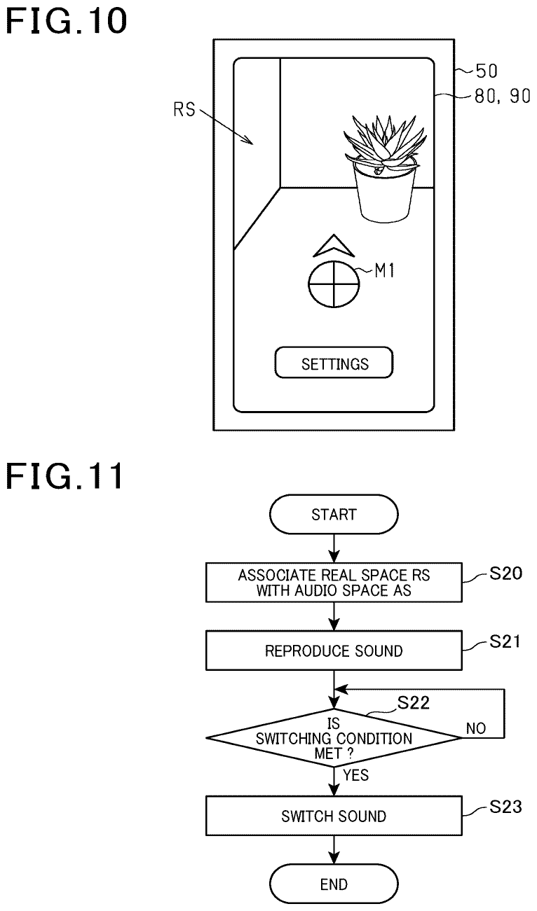

FIG. 10 shows an example where the 3D audio reproduction device 50 is a smartphone. For example, as shown in FIG. 10, based on an instruction from the control device 60, a mark M1 for determining a reference position is displayed on the display unit of the output device 90, superimposed on an image of the surroundings of the user within the real space RS. When the input device 80 is operated in a certain manner, for example, when a section for confirming the reference position is selected, the position at which the mark M1 is superimposed in the image of the real space RS is set as the reference position in the real space RS, and the direction corresponding to the orientation of the mark M1 is set as the reference direction in the real space RS. Positions and directions in the real space RS are specified based on information such as the positions of structures recorded in three dimensions in advance in the real space RS. The positions and directions in the real space RS are associated with the positions and directions in the audio space AS so that the reference position and reference direction in the real space RS coincide with the predetermined reference position and reference direction in the audio space AS.

A different method can be used as long as a 3D correspondence between the real space RS and the audio space AS can be established. For example, the position and orientation of the user in the real space RS may be set as the reference position and reference direction in the real space RS, and then associated with the reference position and reference direction in the audio space AS. In such configuration, since setting the reference position and reference direction in the real space RS using the display unit is not necessary, the output device 90 does not necessarily need to include the display unit. Further, the 3D audio reproduction device 50 does not necessarily need to include the input device 80. The position detection device 70 may be placed at a location separate from the user to detect the position and orientation of the user. In that case, the sound output unit of the output device 90 may be worn or carried by the user, or may be placed at a location separate from the user.

A specific direction in the real space RS may be set as the reference direction in advance. For example, when a display device such as a large display is placed and an image related to a scene produced using 3D audio is displayed on this display device, the direction of the display device relative to the user may be set as the reference direction. The direction of the display device relative to the user is determined using a marker or a sensor. According to such configuration, because it is possible to combine 3D audio with an element other than 3D audio, such as an image aligned with the reference direction, the sense of realism and the interest of the user can be further enhanced.

Next, when a predetermined condition for reproduction is met, such as the input device 80 being operated in a certain manner for instructing reproduction, sounds based on the 3D audio data 62a are reproduced by the sound output unit of the output device 90 based on instructions from the control device 60 (S21). When there are sets of reproducible 3D audio data 62a, the 3D audio to be reproduced may be selected before or after associating the real space RS with the audio space AS.

To be more specific, the control device 60 instructs the output device 90 to reproduce the sound specified by the sound information contained in the 3D audio data 62a at a volume in accordance with the corresponding source position that is a position in the real space RS that corresponds to the source position specified in the audio space AS, and the position of the user in the real space RS. The source position of sound in the audio space AS is specified by the position information contained in the 3D audio data 62a.

For example, the closer the corresponding source position is to the position of the user, the larger the volume. Alternatively, the sound is attenuated when the distance between the corresponding source position and the position of the user is equal to or greater than a predetermined distance. Alternatively, the sound is muted when the distance between the corresponding source position and the position of the user is equal to or greater than a predetermined distance. In addition, the volumes of sounds output from of the left and right earphones or speakers that form the sound output unit are controlled according to the direction of the corresponding source position relative to the position and orientation of the user so that the user perceives the sound to be coming from the corresponding source position.

Any volume control can be performed taking into consideration the position of the audio output unit relative to the user. When the position or orientation of the user in the real space RS change, the volume is changed according to the change in the distance and direction from the position of the user to the corresponding source position.

When the 3D audio data 62a contains information that specifies an element other than the sound and the position, such as reproduction speed information indicating the reproduction speed, this element is also reflected in how the sound is reproduced.

In this way, sounds that constitute the 3D audio are reproduced according to the position and orientation of the user in the real space RS. This gives the user the impression that the sounds are linked to the environment in which the user is located, thereby enhancing the sense of realism of the user.

In the flow shown in FIG. 9, the control unit 61 performs the processing of S20 as the position management unit 61a, and the processing of S21 as the reproduction control unit 61b.

Next, a mode in which scenes are switched by a trigger will be described. An example will be described in which the scene is switched from a first scene to a second scene by switching the reproduced sound. For example, the first scene is a scene on the sea, and sounds such as the sounds of seagulls and waves are reproduced. The second scene is an underwater scene, and sounds such as the sounds of diving and water flowing underwater are reproduced.

S20 and S21 in the flow of processing by the 3D audio reproduction device 50 shown in FIG. 11 are the same as the processing shown in FIG. 9. The processing of S21 causes 3D audio corresponding to the first scene to be reproduced.

After starting to reproduce the sound for the first scene, the control device 60 determines whether a switching condition that is a condition set as a trigger for switching the scene is met (S22). If the switching condition is not met (NO in S22), the control device 60 waits until the switching condition is met. The sound corresponding to the first scene continues to be reproduced during the waiting period.

The switching condition may include, for example, a condition related to the position of the user in the real space RS. The condition related to the position of the user may also be a condition related to the relationship between a specific position and the position of the user in the real space RS, and the specific position may be the corresponding source position of the sound for the second scene.

For example, the switching condition may be that the user moves a predetermined distance from the position at which the user was when the reproduction of the sound for the first scene started. In this case, the condition is a condition related to the position of the user in the real space RS. As another example, the switching condition may be that the user moves into or out of a predetermined range of the reference position in the real space RS. In this case, the reference position in the real space RS corresponds to the above-mentioned specific position. As another example, the switching condition may be that the user moves into a predetermined range of a position in the real space RS corresponding to the source position of the sound for the second scene in the audio space AS. In this case, the condition is a condition related to the relationship between the corresponding source position and the position of the user.

An element other than the position of the user may be set as a switching condition, as long as the element can be detected by the 3D audio reproduction device 50. For example, the switching condition may be a gesture or hand movement of the user, or if the control device 60 is a server and users are reproducing 3D audio in parallel, the switching condition may be that the users make a predetermined gesture or hand movement.

If it is determined that the switching condition is met (YES in S22), the control device 60 instructs the sound output unit of the output device 90 to switch from reproduction of the sound for the first scene to reproduction of the sound for the second scene (S23). This causes the sound of the 3D audio corresponding to the second scene to be reproduced, replacing that for the first scene. In other words, based on the sound information and position information contained in the 3D audio data 62a, sound is reproduced at a volume that corresponds to the position and orientation of the user in the real space RS.

According to the above configuration, a story-like presentation can be achieved: for example, when a user in a scene on the sea where the sounds of seagulls and waves are being reproduced approaches a specific position, the scene may switch to an underwater scene where the sound of a diving is reproduced followed by the sound of water flowing underwater.

As described above, by switching between scenes, more diverse effects can be produced by the 3D audio, thereby enhancing the sense of realism and interest of the user. In particular, when the switching condition includes a condition related to the position of the user in the real space RS, the scene is switched in accordance with the movement of the user, and the spatial relationship between the real space RS and the user is reflected in the sound, further enhancing the sense of realism of the user.

Although an example in which two scenes are switched has been described above, it is also possible to switch between three or more scenes, triggered when respective switching conditions are met. The sounds for the scenes that can be switched between may include a sound that is not 3D audio, that is, a sound that is not configured with a source position and is output at a predetermined volume regardless of the position of the user. In short, it suffices if at least one of scenes involves the reproduction of sound using the 3D audio data 62a.

### Modifications

The configuration and operation of the 3D audio reproduction device 50 described above may be modified as follows.

Sound using the 3D audio data 62a may be reproduced while a virtual space is being displayed on the display unit of the output device 90. The virtual space is, for example, a space in which the user can behave the same way as in a real space such as a store or an event venue. In that case, instead of associating the real space RS with the audio space AS, the control device 60 associates positions and directions in the virtual space with those in the audio space AS, and controls the reproduction so that the sound is reproduced at a volume in accordance with a position in the virtual space corresponding to the source position of the sound specified in the audio space AS, and the position of the user in the virtual space. In such configuration, the display unit only needs to display an image based on data from the control device 20, and does not need to show the user a view of the real space. The virtual space displayed on the display unit may be generated based on data of an existing virtual space or by acquiring drawing data of a space.

As described above, according to the above embodiment, the following effects can be achieved.

The 3D audio generating device 10 is configured to set a source position of sound so that it moves along an object indicating a trajectory drawn in the virtual space VS. Therefore, the user can three-dimensionally specify the source position of sound by drawing a line, a dot, or the like in a 3D space, allowing the user to create 3D audio by an intuitive action.

Furthermore, if the object is a linear object, it is possible to specify how the source position of sound moves by an even more intuitive action.

Since the reproduction speed of sound is set according to the drawing speed, that is, the speed of the movement for drawing the trajectory, the reproduction speed can be determined by an intuitive action.

When the 3D audio data is configured so that sounds each configured with source positions along an object are output in a superimposed manner, complex 3D audio that has sounds emitted from different source positions that can change can be easily created through intuitive actions.

Since the 3D audio generating device 10 can reproduce sound using the generated 3D audio data, a user can easily check the created 3D audio, improving user convenience.

If the 3D audio generating device 10 is configured so that the source position of the sound being reproduced based on the 3D audio data is indicated on an object, the user can visually grasp how the change in the source position of sound, allowing the user to grasp the created 3D audio more intuitively.

The 3D audio reproduction device 50 associates the real space RS with the audio space AS to reproduce sound at a volume according to the positional relationship between the user and a position in the real space RS corresponding to the source position of the sound in the audio space AS. This provides the user the impression that the sound is linked to the environment in which the user is present, and enhances the sense of realism of the user.

Since the 3D audio reproduction device 50 can switch the sound to be reproduced when a predetermined condition is met, it can produce more diverse effects using the 3D audio and enhance the sense of realism and interest of the user.

If the condition for switching sound, in other words, the condition for switching the scene includes a condition related to the position of the user in the real space RS, the scene is switched in accordance with the movement of the user, and the spatial relationship between the real space RS and the user is reflected in the sound, further enhancing the sense of realism of the user.

In particular, if the condition is related to the relationship between a specific position and the position of the user in the real space RS, an experience with enhanced spatial relationship between the user and the real space RS can be created. If the specific position is a position in the real space RS corresponding to the source position of sound in the audio space AS, an experience that effectively links the real space RS with 3D audio can be created. This enhances the sense of realism and interest of the user.

Technical ideas that can be understood from the above-described embodiments and modifications will be described below.

A 3D audio system including a 3D audio generating device and a 3D audio reproduction device, in which the 3D audio generating device includes a drawing management unit that, in response to an instruction from a first user via an input device, places an object in a virtual space showing a trajectory of motion corresponding to the instruction, and a data generating unit that generates 3D audio data in which a selected sound is configured with a source position of the sound that moves along the object, and the 3D audio reproduction device includes a position management unit that acquires a position of a second user in a real space that is a space in which the second user is actually present, and associates a position in the real space with a position in the virtual space, and a reproduction control unit that controls reproduction of sound using the 3D audio data, and instructs a sound output unit of an output device to reproduce the sound at a volume corresponding to a relationship between a corresponding source position that is a position in the real space corresponding to the source position of the sound in the virtual space, and a position of the second user.

According to this configuration, the 3D audio generating device can be used to three-dimensionally specify the source position of sound by drawing a line in a 3D space. This allows the first user to create 3D audio by an intuitive action. Since the 3D audio reproduction device can be used to provide the second user the impression that the sound is linked to the environment in which the second user is present, the sense of realism of the second user can be enhanced.

A 3D audio reproduction device controls reproduction of sound using 3D audio data containing sound information and position information that specifies a source position of the sound indicated by the sound information in an audio space that is a virtual 3D space. The 3D audio reproduction device includes: a position management unit that acquires a position of a user in a real space that is a space in which the user is actually present, and associates a position in the real space with a position in the audio space, and a reproduction control unit that instructs a sound output unit of an output device to reproduce the sound at a volume corresponding to a relationship between a corresponding source position that is a position in the real space corresponding to the source position of the sound in the audio space, and a position of the user.

According to this configuration, sound is reproduced at a volume that corresponds to the position of the user in real space to give the user the impression that the environment in which the user is located is linked to how the sound is reproduced. As a result, the sense of realism of the user can be enhanced.

3D audio systems reproduce sounds so that a user can three-dimensionally perceive the direction, distance, spread, and the like of the sound. For example, the system described in JP 2022-34160 A has multiple speakers provided so as to surround a user who is playing a video game, and creates a 3D sound field by controlling the output of each speaker according to the movements of the character controlled by the user.

Conventional software for creating and editing sound data is configured to perform desired operations on sound represented by a waveform or the like on a two-dimensional (2D) plane in which one of the two axes represents time. Because 3D audio data needs to be generated so as to contain 3D information such as the source position of sound, a representation that uses a 2D plane makes it difficult to generate data intuitively.

A 3D audio generating device according to an embodiment of the present invention includes: a drawing management unit that places an object in a virtual space in response to an instruction from a first user via an input device; and a data generating unit that generates 3D audio data in which a selected sound is configured with a source position of the sound so that the source position matches a position of the object.

According to this configuration, the user can three-dimensionally specify the source position of sound based on the position of the object in a 3D space, allowing the user to create 3D audio by an intuitive action.

In the 3D audio generating device, the drawing management unit may place, as the object, an object in the virtual space that shows a trajectory of motion corresponding to the instruction from the first user, and the data generating unit may generate the 3D audio data by setting the source position of the sound so that the source position moves along the object.

According to this configuration, the user can three-dimensionally specify the source position of sound by drawing a line, a dot, or the like in a 3D space, allowing the user to create 3D audio by an intuitive action.

In the 3D audio generating device, the object placed by the drawing management unit may include a linear object.

According to this configuration, it is possible to specify how the source position of sound moves by an even more intuitive action.

In the 3D audio generating device, the 3D audio data may contain information that specifies a reproduction speed of the sound, and the data generating unit may generate the 3D audio data by setting the reproduction speed of the sound to a speed corresponding to a speed of the motion.

According to this configuration, since the reproduction speed of sound is set according to the drawing speed, that is, the speed of the movement for drawing the trajectory, the reproduction speed can be determined by an intuitive action.

In the 3D audio generating device, the data generating unit may set a source position for each of sounds so that each source position moves along the object for that sound, and generate the 3D audio data configured to output the sounds in a superimposed manner.

According to this configuration, complex 3D audio that has sounds emitted from different sources positions that can change can be easily created through an intuitive action.

The 3D audio generating device may further include a reproduction control unit that instructs a sound output unit of an output device to reproduce the sound at a volume corresponding to the set source position, based on the 3D audio data.

According to this configuration, user convenience can be improved because a user can easily check the created 3D audio.

In the 3D audio generating device, the 3D audio generating device may cause a display unit of the output device to display an image of the virtual space in which the source position of the sound being reproduced based on the 3D audio data is shown on the object.

According to this configuration, the user can visually grasp the change in source position, and therefore can grasp the created 3D audio more intuitively.

A 3D audio reproduction device according to another embodiment of the present invention controls reproduction of sound using the 3D audio data generated by the 3D audio generating device. The 3D audio reproduction device includes: a position management unit that acquires a position of a second user in a real space that is a space in which the second user is actually present, and associates a position in the real space with a position in the virtual space; and a reproduction control unit that instructs a sound output unit of an output device to reproduce the sound at a volume corresponding to a relationship between a corresponding source position that is a position in the real space corresponding to the source position of the sound in the virtual space, and a position of the second user.

According to this configuration, sound is reproduced at a volume that corresponds to the position of the user in real space to give the user the impression that the environment in which the user is located is linked to how the sound is reproduced. As a result, the sense of realism of the user can be enhanced.

In the 3D audio reproduction device, a condition for switching sound to be reproduced may be set, and the reproduction control unit may instruct the sound output unit to switch the sound to be reproduced when the condition is met.

According to this configuration, it is possible to produce diverse effects using the 3D audio and enhance the sense of realism and interest of the user.

In the 3D audio reproduction device, the condition may include a condition related to a position of the second user in the real space.

According to this configuration, since the spatial relationship between the real space and the user is reflected in the sound, the sense of realism of the user is further enhanced.

In the 3D audio reproduction device, the condition may include a condition related to a relationship between a specific position and a position of the second user in the real space.

According to this configuration, an experience with enhanced spatial relationship between the real space and the user can be created.

In the 3D audio reproduction device, the reproduction control unit may instruct the sound output unit to switch from reproduction of a first sound to reproduction of a second sound when the condition is met, the second sound may be a sound reproduced using the 3D audio data, and the specific position in the real space may be the corresponding source position of the second sound.

According to this configuration, an experience can be created that effectively associates the 3D audio with the spatial relationship between the real space and the user. This enhances the sense of realism and interest of the user.

In a 3D audio generation method according to another embodiment of the present invention, one or more computers place an object in a virtual space in response to an instruction from a first user via an input device, and generate 3D audio data in which a selected sound is configured with a source position of the sound so that the source position matches a position of the object.

According to this method, the user can three-dimensionally specify the source position of sound based on the position of the object in a 3D space, allowing the user to create 3D audio by an intuitive action.

A 3D audio generating program according to another embodiment of the present invention causes one or more computers to place an object in a virtual space in response to an instruction from a first user via an input device, and generate 3D audio data in which a selected sound is configured with a source position of the sound so that the source position matches a position of the object.

In a computer readable memory medium according to another embodiment of the present invention, the 3D audio generating program is recorded.

According to this configuration, the user can three-dimensionally specify the source position of sound based on the position of the object in a 3D space, allowing the user to create 3D audio by an intuitive action.

According to an embodiment of the present invention, a user can create 3D audio through an intuitive action.

Obviously, numerous modifications and variations of the present invention arc possible in light of the above teachings. It is therefore to be understood that within the scope of the appended claims, the invention may be practiced otherwise than as specifically described herein.

1. A 3D audio generating device, comprising:
a control unit comprising circuitry configured to place an object in a virtual space in response to an instruction from a first user via an input device and generate 3D audio data in which a selected sound is configured with a source position of the sound such that the source position matches a position of the object.

2. The 3D audio generating device according to claim 1, wherein the circuitry of the control unit is configured to place, as the object, an object in the virtual space that shows a trajectory of motion corresponding to the instruction from the first user, and generate the 3D audio data by setting the source position of the sound such that the source position moves along the object.

3. The 3D audio generating device according to claim 2, wherein the object placed by the circuitry of the control unit includes a linear object.

4. The 3D audio generating device according to claim 2, wherein the 3D audio data includes information that specifies a reproduction speed of the sound, and the circuitry of the control unit is configured to generate the 3D audio data by setting the reproduction speed of the sound to a speed corresponding to a speed of the motion.

5. The 3D audio generating device according to claim 2, wherein the circuitry of the control unit is configured to set a source position for each of a plurality of sounds such that each source position moves along the object for that sound, and generate the 3D audio data configured to output the sounds in a superimposed manner.

6. The 3D audio generating device according to claim 2, wherein the circuitry of the control unit is configured to instruct a sound output unit of an output device to reproduce the sound at a volume corresponding to the set source position based on the 3D audio data.

7. The 3D audio generating device according to claim 6, wherein the 3D audio generating device is configured to cause a display of the output device to display an image of the virtual space in which the source position of the sound being reproduced based on the 3D audio data is shown on the object.

8. The 3D audio generating device according to claim 3, wherein the 3D audio data includes information that specifies a reproduction speed of the sound, and the circuitry of the control unit is configured to generate the 3D audio data by setting the reproduction speed of the sound to a speed corresponding to a speed of the motion.

9. The 3D audio generating device according to claim 3, wherein the circuitry of the control unit is configured to set a source position for each of a plurality of sounds such that each source position moves along the object for that sound, and generate the 3D audio data configured to output the sounds in a superimposed manner.

10. The 3D audio generating device according to claim 3, wherein the circuitry of the control unit is configured to instruct a sound output unit of an output device to reproduce the sound at a volume corresponding to the set source position based on the 3D audio data.

11. The 3D audio generating device according to claim 10, wherein the 3D audio generating device is configured to cause a display of the output device to display an image of the virtual space in which the source position of the sound being reproduced based on the 3D audio data is shown on the object.

12. The 3D audio generating device according to claim 4, wherein the circuitry of the control unit is configured to set a source position for each of a plurality of sounds such that each source position moves along the object for that sound, and generate the 3D audio data configured to output the sounds in a superimposed manner.

13. The 3D audio generating device according to claim 4, wherein the circuitry of the control unit is configured to instruct a sound output unit of an output device to reproduce the sound at a volume corresponding to the set source position based on the 3D audio data.

14. A 3D audio reproduction device, comprising:
a control unit comprising circuitry configured to acquire a position of a second user in a real space that is a space in which the second user is actually present, associate a position in the real space with a position in the virtual space, and instruct a sound output circuitry of an output device to reproduce the sound at a volume corresponding to a relationship between a corresponding source position that is a position in the real space corresponding to the source position of the sound in the virtual space, and a position of the second user,
wherein the 3D audio reproduction device is configured to control reproduction of sound using the 3D audio data generated by the 3D audio generating device of claim 1.

15. The 3D audio reproduction device according to claim 14, wherein a condition for switching sound to be reproduced is set, and the circuitry of the control unit is configured to instruct the sound output circuitry to switch the sound to be reproduced when the condition is met.

16. The 3D audio reproduction device according to claim 15, wherein the condition includes a condition related to a position of the second user in the real space.

17. The 3D audio reproduction device according to claim 16, wherein the condition includes a condition related to a relationship between a specific position and a position of the second user in the real space.

18. The 3D audio reproduction device according to claim 17, wherein the circuitry of the control unit is configured to instruct the sound output circuitry to switch from reproduction of a first sound to reproduction of a second sound when the condition is met, the second sound is a sound reproduced using the 3D audio data, and the specific position in the real space is the corresponding source position of the second sound.

19. A 3D audio generation method,
placing an object in a virtual space in response to an instruction from a first user via an input device, using at least one computer; and
generating 3D audio data in which a selected sound is configured with a source position of the sound such that the source position matches a position of the object, using the at least one computer.

20. A non-transitory computer readable memory medium stored therein a 3D audio generating program that when executed, causes at least one computer to place an object in a virtual space in response to an instruction from a first user via an input device. and generate 3D audio data in which a selected sound is configured with a source position of the sound so that the source position matches a position of the object.
